(19) United States
(12) Patent Application Publication
(10) Pub. No.: US 2008/0082507 A1
(43) Pub. Date: Apr. 3, 2008

(54) SYSTEM AND METHODS FOR PROVIDING CONTENT OVER A DATA COMMUNICATIONS NETWORK AND COMPENSATING CONTENT OWNERS AND RESOURCE PROVIDERS

(75) Inventors: Samuel Tarantino, Tarpon Springs, FL (US); Joshua Greenberg-Sanders, St. Petersburg, FL (US); Andres H. Barreto, Miramar, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC., Gainesville, FL (US)

(21) Appl. No.: 11/864,977

(22) Filed: Sep. 29, 2007

Related U.S. Application Data
(60) Provisional application No. 60/827,562, filed on Sep. 29, 2006.

(51) Int. Cl. G06F 7/06; G06F 17/30

(52) U.S. Cl. 707/3; 707/102; 707/104.1; 707/E17.009; 707/E17.005

(57) ABSTRACT

A method for providing data content over a data communications network and compensating data content providers and data content owners is provided. According to the method, in response to a search query conveyed from a data content requester over the data communications network, at least one network-connected node which stores at least a portion of data content is identified based upon the search query. If different portions of the data content are stored at different nodes, each of the different nodes is identified and the respective portions of data content to generate a complete data package is downloaded. Provider compensation is provided to each content provider at each of the different nodes, the provider compensation being based upon resources contributed from each node for delivering the complete data package to the data content requester. Owner compensation is provided to each owner of the data content, the owner compensation being based upon a predetermined ownership compensation formula.

### CROSS-REFERENCE TO RELATED APPLICATIONS

The present application claims the priority of U.S. Provisional Application Ser. No. 60/827,562 filed on Sep. 29, 2006, which is incorporated herein by reference in its entirety.

### FIELD OF THE INVENTION

The present invention is related to the field of data communications, and more particularly, to providing data content over a data communications network and to compensating providers and owners of the data content.

### BACKGROUND OF THE INVENTION

The linking of computers to form a data communications network, such as the Internet, provides an efficient mechanism for distributing data content to widely dispersed users of data content. Moreover, the increasing sophistication of the underlying technologies, in terms of both software and hardware, has made it possible to provide data content in many different forms beyond text and graphics. The MPEG-1 Audio Layer-3, industry standard format, for example, allows an audio sequence to be compressed into an audio file that can be efficiently conveyed via the Internet without significantly sacrificing the quality of the original sounds of the sequence when it is subsequently downloaded and rendered on a computing or communication device. Video coding similarly provides coding formats for the efficient conveyance of digital video files over the Internet. Audio, audiovisual, and other multimedia files conveyed over the Internet have become a significant source of news and entertainment.

The ease with which such files can be shared over data communications networks, however, has given rise to problems for copyright holders and other owners of data content. For example, music industry revenues were adversely affected by free peer-to-peer (P2P) systems that allowed wide-spread sharing of music files, typically without compensation to copyright holders. Some in the film industry have expressed concerns that similar problems could arise as a result of the sharing of audiovisual files as underlying technologies continue to advance.

Accordingly, there is a need for a scheme that enables consumers to efficiently obtain songs, movies, or other types of data content without denying owners of the underlying data content the compensation to which they are entitled. There is the further need for a scheme that provides incentives for data content users to provide network resources needed for efficient distribution of data content to other users, while also operating within a structured environment that takes account of the rights of the owners of data content.

### SUMMARY OF THE INVENTION

The present invention is directed to a system, device, and methods for motivating network-linked computer users to provide resources for distributing data files via a data communications network and also for compensating owners of data content provided over a data communications network. The invention, in one aspect, can be used to create a network-based community within which members can discover, comment on, and contribute to the distribution of various forms of data content, while data content owners can be adequately compensated for allowing the distribution their data content over the network.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic diagram of data communications network that includes a computing device for providing data content over the data communications network and for compensating providers and owners of the data content, according to one embodiment of the invention.

FIG. 2 is a schematic diagram of the computing device illustrated in FIG. 1.

FIG. 3 is a schematic diagram illustrating certain operative aspects of the computing device illustrated in FIG. 1.

FIG. 4 is a schematic diagram illustrating certain additional operative aspects of the computing device illustrated in FIG. 1.

FIG. 5 is a schematic diagram of a computing system for providing data content and supplementary information provided by members of a network-based community, according to another embodiment of the invention.

FIG. 6 is a flowchart of exemplary steps of a method for providing data content over a data communications network, according to yet another embodiment of the invention.

FIG. 7 is a flowchart of exemplary steps of a method for providing data content over a data communications network and for compensating data content providers and data content owners, according to still another embodiment of the invention.

### DETAILED DESCRIPTION

The present invention provides a system, device, and methods for distributing data content over a data communications network. The invention can provide incentives to network-connected computer users for contributing resources, such as bandwidth, to the distribution of the data content, while also providing a mechanism by which owners of the data content are compensated for allowing the data content to be distributed over the data communications network.

As described herein, the system, device, and methods can be utilized to create a network-based community of interests whereby network-connected members can discover, recommend, and comment on different types of data content. For example, in the context of data content comprising music files, the invention can create a community of music aficionados that is both efficient and equitable to copyright holders as well as consumers. The network thus created allows compensation to be paid to copyright holders for the enjoyment of copyrighted songs, while also determining compensation for network-connected consumers who provide bandwidth or other resources, described more particularly below, for distributing the songs over the data communications network that supports the underlying network-based community. Other types of data content for which the system, device, and methods described herein can be utilized include, for example, video files, eBooks, electronic documents, and software programs. Indeed, as will be apparent from the illustrative descriptions provided herein, the system, device, and methods can be utilized with respect to any type of electronic data, whether provided as a file or simply a block of data.

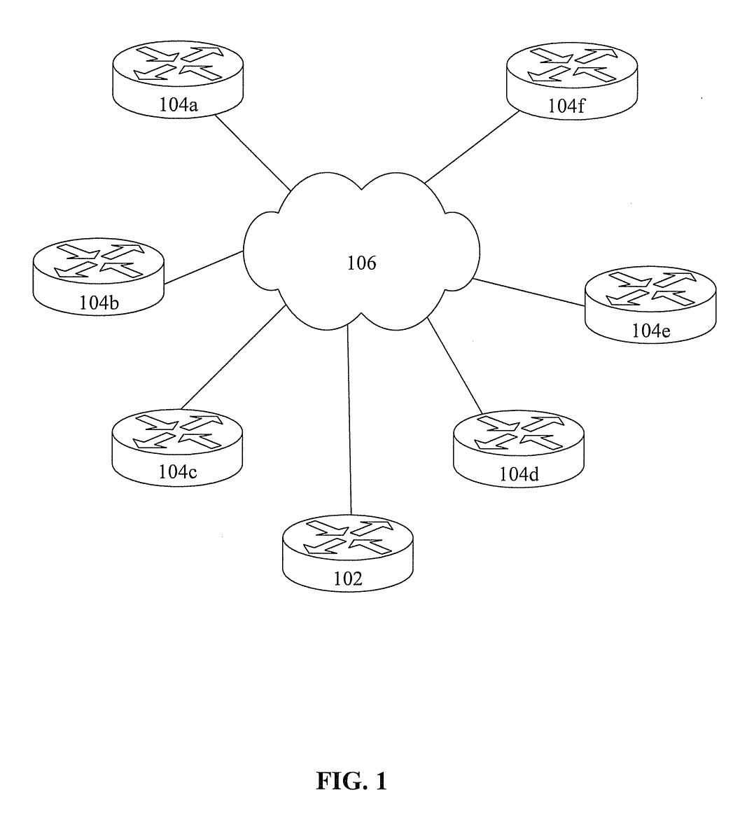

FIG. 1 is a schematic diagram of an exemplary data communications network 100 that, according to one embodiment of the invention, includes a network-connected computing device 102 configured to provide data content over the data communications network 100 and to determine compensation for providers and owners of the data content. As shown, the data communications network 100 further includes a plurality of other network-connected computing devices 104a-f through which data content users obtain and exchange data content. Illustratively, the computing devices 102, 104a-f are linked through one or more additional computing devices, or network nodes 106, that comprise a data communications network, such as the Internet, a wide-area network (WAN), or a local-area network (LAN). In an alternative embodiment, however, at least two of the network-computing devices 102, 104a-f can be in direct communication with one another rather than communicating through one or more additional network nodes.

Although the computing device 102 is illustratively connected to six other computing devices 104a-f of the data communications network 100, it will be readily apparent that the computing device can connect to fewer other computing devices or, as is more likely, can connect to a much greater number of other computing devices. Moreover, although the computing device 102 is illustratively connected with the other computing devices 104a-f via wire-line connections, it should be noted that two or more of the computing devices can be alternatively linked via wireless connections.

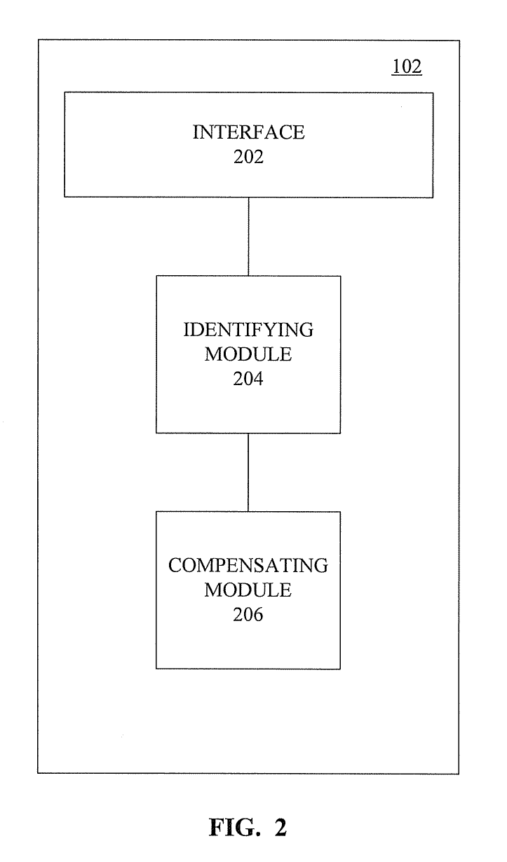

Referring additionally now to FIG. 2, the computing device 102 illustratively includes a data communications network interface 202 through which the computing device 102 is able to communicate with the plurality of other computing devices 104a-f, either directly or via other network nodes 106 of the data communications network 100. The computing device 102 further illustratively includes an identifying module 204 configured to identify one or more of the other computing devices 104a-f as a provider computer. A particular computing device identified by the identifying module 204 as a provider computer is any device that is capable of providing at least a portion of requested data content. Requested data content comprises data content that is requested in a query conveyed to the computing device 102 by another of the plurality of computing devices 104a-f, the latter computing device defining a requester computer.

The computing device 102 also illustratively includes a compensation-determining module 206. The compensation-determining module 206 determines compensations, defined as provider compensations, which compensate one or more computing devices that provide data content in response to a received request for data content. Additionally, or alternatively, the compensation-determining module 206 also determines an amount of owner compensation for an owner of the data content that is provided to the requester computer.

The compensation-determining module 206 determines compensation for a particular provider computer based upon an amount of resources, such as bandwidth, that the provider computer provides to the requester computer for obtaining at least a portion of the requested data content involve anything that users do to help out other users. As used herein, bandwidth encompasses the computing resources of one or more computing devices made available to another computing device, such as to facilitate file and data uploads and downloads, with uploads occurring, for example, with files sent to other users and downloads occurring, for example, with files requested by a user and received from others.

Compensation for other forms of resource contribution, alternatively or additionally, can be determined by the compensation-determining module 206, depending on a particular configuration. For example, again in the specific context of music files, compensation can be determined for resource contributions that include, for example: posting comments on one or more songs, artists, or albums; tagging one or more songs, artists, or albums; correcting relevant data pertaining to one or more songs, artists, or albums; creating one or more playlists and adding content to the playlists; scanning one or more files and making those files available for distribution to other users; rating one or more songs, artists, or albums.

Still other resource contributions for which the compensation-determining module 206 can determine compensation include, for example: a user's contributing resources by creating one or more groups of network-connected users; joining one or more such groups; rating the quality of a data content file; publishing notification of events pertaining to the data content; and sharing information pertaining to the data content via blogs, email, or other network communication mechanisms. Indeed, because the network-connected computing devices 102, 104a-f can effectively constitute a community of users who share an interest in the particular subject matter to which certain data content pertains, the compensation-determining module 206 can be configured to determine the compensation to any user whose contribution enhances the value of the community to other users.

According to still another embodiment, the compensation-determining module 206 can determine compensation for a particular provider computer based upon a user's transaction history; that is, based upon past resource usage by and/or past resource contributions from the provider computer. For example, in determining compensation based upon a transaction history, the compensation-determining module 206 can compute a ratio of data content, such as number of songs, purchased to data content provided. This computation can be used to determine how much a user has been paid for data content in proportion to how much data content the user has purchased.

Given the different types of resource contributions for which compensation can be made, the compensation-determining module 206 can be configured to determine compensation as a weighted value based on different types of resource contributions made. For example, according to one embodiment, the compensation-determining module 206 is configured to determine a weighted value of compensation per user based upon bandwidth contribution, different community-based contributions of the types described above, and data content purchased versus data content provided.

Moreover, in instances in which data content is provided from more than one provider computer—for example, if a requested data content file is split into four portions, each coming from a different provider computer, and reconstructed at the requestor computer—compensation can be effected with the compensation-determining module 206 in alternate ways. One way is for the compensation-determining module 206 to compensate one of the provider computers initially and to determine a compensation for each of the other provider computers that is made during one or more future network-based transactions. Alternatively, the compensation-determining module 206 can be configured to compensate each provider computer equally. According to yet another embodiment, however, the compensation-determining module 206 can be configured to compensate each provider computer in proportion to the amount of the requested file that each provides to the requester computer.

The components of the computing device 102 - in particular, the network interface 202, the identifying module 204, and the compensation-determining module 206—can be implemented in dedicated hardwired circuitry. Alternatively, the network interface 202, the identifying module 204, and/or the compensation-determining module 206 can be implemented in computer-implemented code configured to execute on an application-specific computing device or a general-purpose computing device. In still another embodiment, the network interface 202, the identifying module 204, and/or the compensation-determining module 206 can be implemented in a combination of code and hardwired circuitry.

Illustratively, the identifying module 204 and the compensation-determining module 206 are co-located in a single-device chassis that contains the network interface 202. In an alternative embodiment, however, one or both of the modules 204, 206 can be a distributed components remotely located from, but in communication with, the network interface 202.

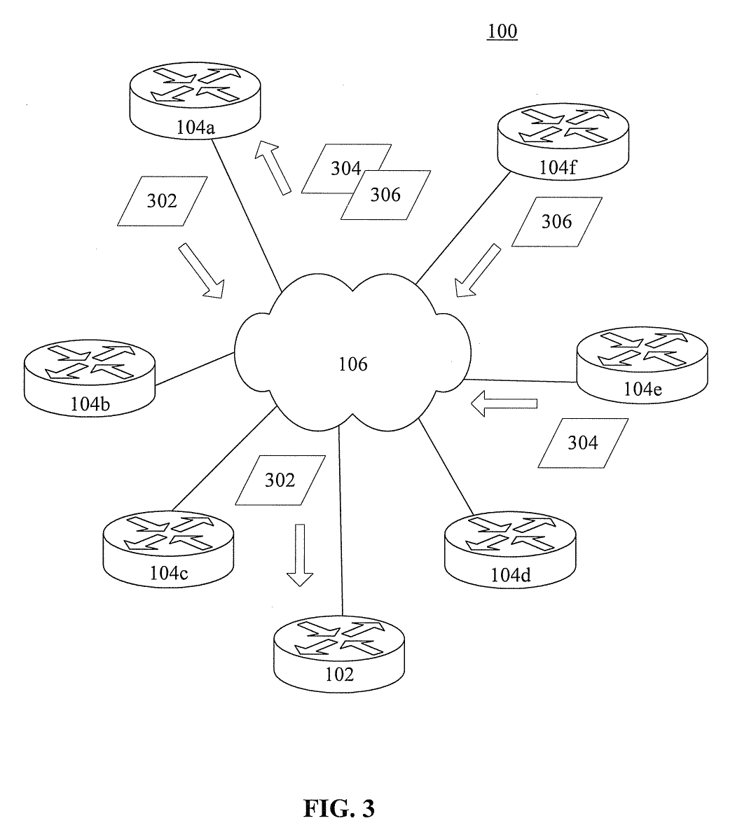

FIG. 3 provides a schematic view of certain operative aspects of the computing device 102 when it is operating within the exemplary data communications network 100. As illustrated, one of the other network-connected computing devices 104a initiates the operative features by submitting a query 302 to the computing device 102. The query 302, more particularly, can contain one or more keywords. For example, if the data content-comprises an audio file of a requested song, the query can include the name of the song, a name of an artist performing the song, a recording producer or record label, the date of the song's recording, or other indicia for identifying the song. Similarly, if the data content comprises a visual file for rendering a requested film, then the query can include the name of the film, a name of an artist appearing in the film, the name of the film's director or producer, the date of the film's release, or other indicia for identifying the film.

The identifying module 204 responds to the query by identifying which of the other computing devices 104b-f is a provider computer; that is, which of the computing devices 104b-f can access and provide at least a portion of the requested data content. Identifying particular data content can be done based on hashing or electronic fingerprinting, for example. According to one embodiment, the identifying module 204 can store or access a centralized database (not explicitly shown) listing the particular data content available at each particular computing device 104b-f. For example, in the context of data content comprising audio files of songs, the database can provide one or more keywords associated with the audio file. The database, accordingly, can provide a listing of each song available from each computing device, even when a user logs off and shuts down the device so that is not linked to the data communications network 100. Each computing device 104b-f can broadcast the songs available when a user logs on to the data communications network, when the data content (i.e., set of songs) available at the particular computing device changes, or when a request is sent to the particular computing device requesting certain data content (i.e., a particular set of songs).

Alternatively, a decentralized source for identifying data content can be utilized. For example, again, in the context of audio files of songs, a computing device 104b-f can store an encrypted library detailing each song available from the device. In yet another embodiment, in which data content is not pre-indexed, the identifying module 204 can identify which of the computing devices 104b-f is capable of providing at least a portion of the requested data content by performing a series of “hops” across different network nodes. Each node searches its library in response to the query requesting data content and determines whether or not it contains the data content requested.

Once those computing devices 104b-f capable of providing at least portions of the requested data content have been identified as provider computers by the identifying module 204, each of the respective portions of the data content is provided by the provider computers. The different portions, moreover, can be aggregated to construct a complete data file, such as an audio file for rendering a requested song or a visual file for rendering a requested film.

According to one embodiment, when the requester computer 104a receives portions of data content from two or more having been identified as capable of providing a portion of the requested data content—that is, identified provider computers 104e, 104f—the requestor computer 104a downloads the different portions. Specifically, once all of the different portions are received at the requestor computer 104a, the different portions are joined in proper sequence to form a complete package of the requested data content. For example, if the data content comprises an audio file for rendering a song, the computing device 102, after identifying the provider computers 104e, 104f, verifies the connectivity of each. Specifically, the preferences of each are checked to ensure that file uploads have not been disabled for either. The bandwidth of each provider computer 104e, 104f is tested to ensure that each is connected properly to the data communications network 100.

Each provider computer 104e, 104f that meets these criteria is selected as data content source, and the computing device 102 sends requests to each requesting portions of a complete file. The computing device 102 can record each request in a database (not explicitly shown) so as to identify which provider computer sends which portion and the proper order for generating a complete file. As each portion is received, a new request can be sent to an appropriate provider computer for any available portions yet needed to generate the complete data file. This shifts more bandwidth towards provider computers having more efficient, more rapid connections. It should be noted that connected provider computers are expected to transmit multiple, discrete portions of data content. This allows a better shift of bandwidth among the various computing devices as downloading is performed. For example, if five computing devices are identified and then selected to provide portions of data content comprising a 5 MB file, each portion transmitted over the data communications network 100 is unlikely be 1 MB is size, but rather in the neighborhood of 50 kb. This would cause each provider computer to be queried approximately 100 times on average. However, as already noted, those provider computers having faster connections would be queried more than the average number of times, while those having slower connections would be queried fewer than the average number of times.

According to a particular embodiment, data content provided by the provider computer 102 can be encrypted before it is conveyed over the data communications network 100. The requester computer 104a, accordingly, receives an encoded version of a file instead of the file itself. According to this embodiment, the encrypted file is unlocked using a private key that has either already been provided and is stored by the requestor computer 104a or that is obtained from a remotely located database stored at still another device communicatively linked to the data communications network 100.

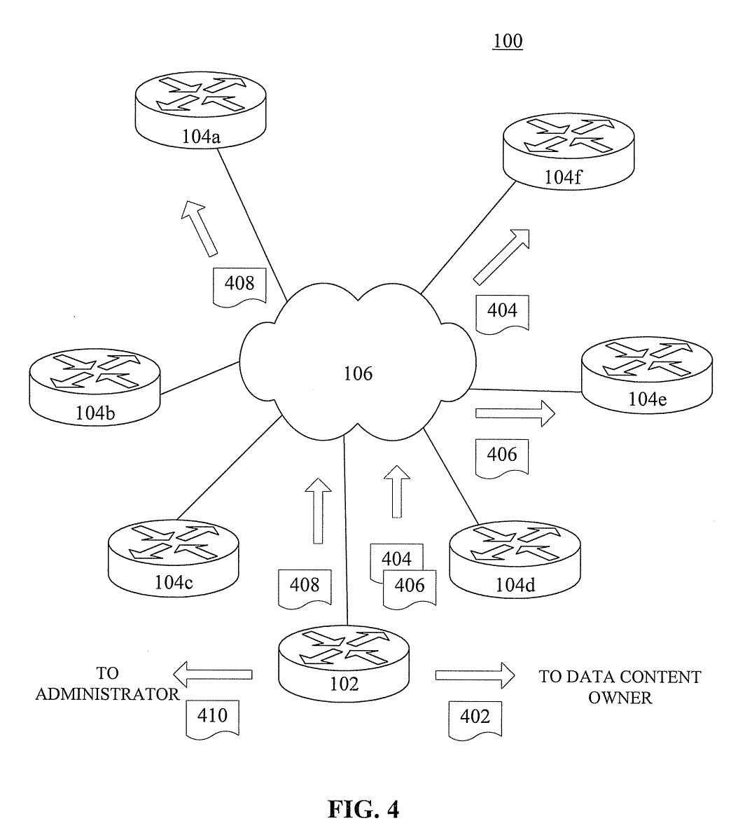

FIG. 4 schematically illustrates additional operative features of the computing device 102, particularly those of determining compensations for the identified provider computers based on the amount resources each provides to the requestor computer, as well as compensation for legal owners of the data content provided. As shown, the compensation-determining 206 determines an owner compensation owed to the legal owner of the data content and the computing device 102 generates a compensation message that is conveyed to the owner. According to one embodiment, the computing device 102, rather than notifying an owner of each download, instead records and stores details of each transaction corresponding to a separate downloading of a file. The computing device 102 can create an accounts payable pool, that tracks funds that are to be distributed to various owners or rights holders of different data content. Accordingly, a more efficient compensation mechanism is effected by making periodic payments based on the recorded transactions.

The compensation-determining module 206 further computes the compensation owed to each provider computer 104e, 104f. The computing device 102 generates provider messages 404, 406 that are conveyed to the respective provider computers 104e, 104f. A separate message 408 can be conveyed to the requester computer 104a, informing the user of the compensation determined and owed by the user. An administrative compensation for maintaining the network-based community for users can also be determined, and a corresponding message 410 sent to the administrator.

According to a particular embodiment, a requestor computer 104a that is a member of a network-based music community sends a query to the computing device 102 requesting a song is able to obtain from identified provider computers 104e, 104f portions of an audio file for rendering the song. The requestor computer 104a downloads the respective portions to obtain the complete audio file and pays a fee to an administrator. The administrator pays half the fee to the member of the network that has the highest ratio of songs purchased, Sp, to songs provided, Ss:Sp|Ss. The administrator pays, for example, 37.5 percent of the fee to the copyright holder of the song and retains 12.5 percent of the fee to cover administrative overhead and a reasonable return for administrative services. It will be readily apparent that various other compensation schemes can be effected through the invention. Different criteria can be employed to determine the compensation for one or more provider computers. Likewise, different rates of compensation can be negotiated with owners and other rights holders of the data content.

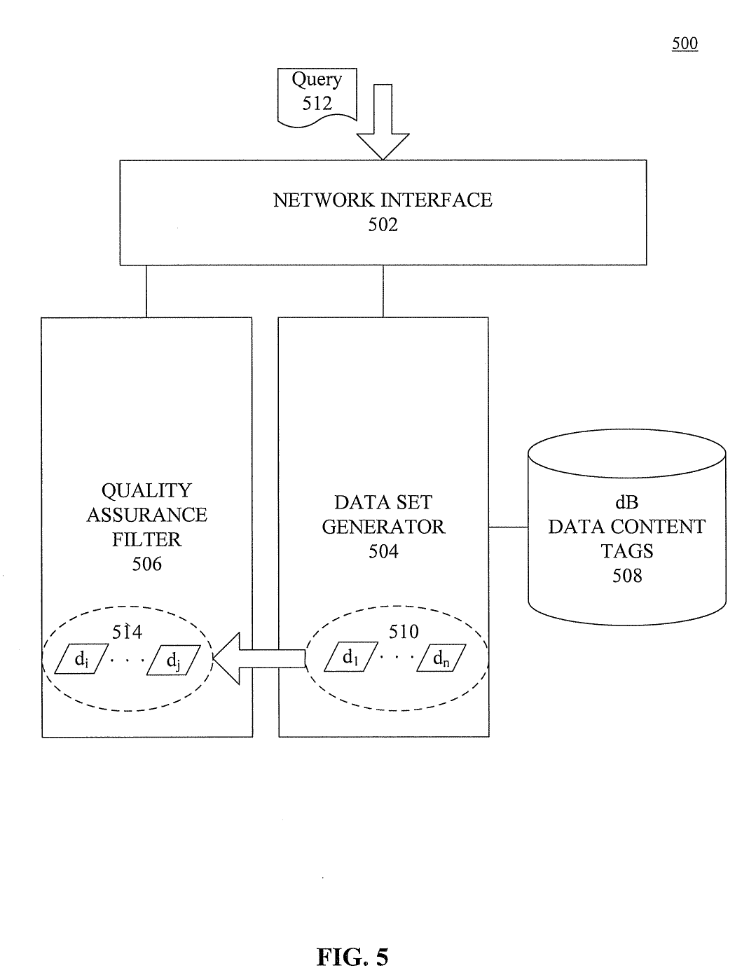

FIG. 5 is a schematic diagram of a computing system 500 for providing data content, according to another embodiment of the invention. The system illustratively includes a network interface 502 for communicating with a plurality of computing systems, defining network nodes (not explicitly shown), over a data communications network. The system 500 further illustratively includes a data set generator 504 in communication with the network interface 502. The system also illustratively includes a quality assurance filter 506, also in communication with the network interface 502 as well as the data set generator 504. Additionally, the system 500 a database 508 in communication with the data set generator 504.

Operatively, the data set generator 504 generates a set of data content 510 in response to a query 512 conveyed over the data communications network. More particularly, the data set generator 504 is configured to generate the set based upon at least one keyword contained in the query 512 and at least one corresponding keyword associated with data content stored in data libraries (not shown) at the plurality of different network-connected nodes of the data communications network. The quality assurance filter 506 is configured to generate an additional set 514 by eliminating from the data set initially generated that data content that fails to satisfy a predetermined quality criterion. The database 508 illustratively contains content tags that are associated with the set of data content. More particularly, each tag can comprise commentary pertaining to the data content, recommendations regarding the data content, user-supplied ratings of the data content, and other information that supplements the data content to which the particular tag or tags correspond.

According to one embodiment, the data content 510 comprises one or more digital audio files for rendering a song identified by at least one keyword contained in the query 512 and at least one corresponding keyword associated with data content stored in data libraries at a plurality of network-connected nodes of the data communications network. The initial data set 510, accordingly, can be generated by obtaining data content from one or more of the data libraries based upon the associated keywords. The tags in the database 508 can include commentary pertaining to the song, recommendations regarding the song, commentary pertaining to an artist performing the song, recommendations regarding other songs performed by an artist performing the song, user-supplied ratings of the song, and user-supplied ratings of an artist performing the song, as well as other information pertinent to the song or a particular artist.

According to another embodiment, the data content 510 comprises one or more digital video files for rendering a visual performance identified by the at least one keyword contained in the query 512 and the at least one corresponding keyword associated with data content stored in data libraries at a plurality of network-connected nodes of the data communications network. Thus, according to this embodiment as well, the set of data content 510 can be generated from different data elements obtained from the plurality of data libraries. The corresponding tags of the database 508, accordingly can pertain to commentaries regarding the visual performance, recommendations regarding the visual performance, commentaries on an artist appearing in the visual performance, commentaries on the director of the visual performance, commentaries on the script of the visual performance, recommendations regarding related visual performances, and user-supplied ratings of the visual performance.

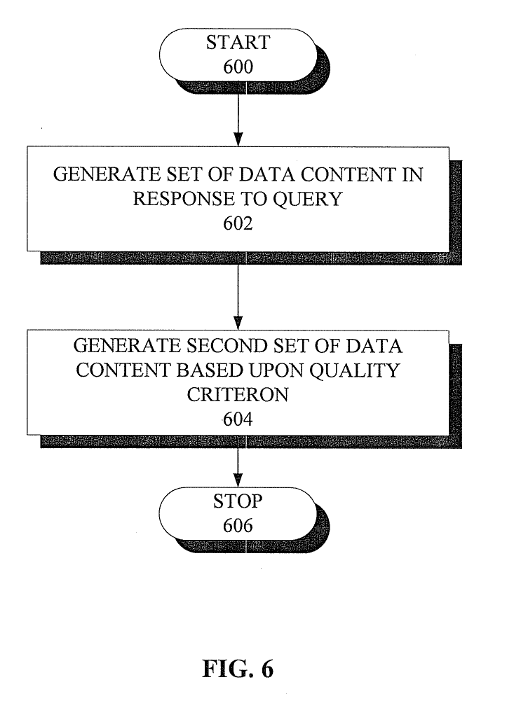

FIG. 6 is a flowchart of exemplary steps illustrative of a method 600 of providing data content over a data communications network, according to still another embodiment of the invention. At step 602, in response to a query conveyed over the data communications network, a first set of data content is generated. The first set of data content generated at step 602 is generated based upon at least one keyword contained in the query as well as at least one corresponding keyword associated with data content stored in data libraries at a plurality of network-connected nodes of the data communications network. A second set of data content is generated at step 604. The second set of data content is generated as step 604 by applying a quality assurance filter. The applied quality assurance filter eliminates from the first set of data generated that data content that fails to satisfy a predetermined quality criterion.

According to one embodiment, the first and second sets of data content generated are digital audio files, each capable of rendering a song associated with the keyword or keywords contained in the query and at least one corresponding keyword associated with the data content stored in the data libraries. Accordingly, applying the quality assurance filter at step 604 can comprise eliminating from the first set of data content each audio file contained therein that is incapable of rendering a complete version of the song. Additionally, or alternatively, the step 604 can eliminate from the first set of data content each audio file having a bit rate less than a pre-selected threshold. The threshold can be, for example, 128 kbps. It will be readily apparent, however, that is possible to vary the bit rate threshold. Indeed, the bit rate threshold can be varied depending on network and various other technical constraints.

According to this embodiment in which a complete audio file is capable of rendering a requested song, the method 600 can further include applying at least one tag to each audio file. A tag, accordingly, can include the name of an artist performing a song rendered by a corresponding audio file, track information of a corresponding audio file, commentary about a song rendered by a corresponding audio file, a recommendation regarding a song rendered by a corresponding audio file, recommendations regarding related songs rendered by a corresponding audio file, ratings of a song rendered by a corresponding audio file, and/or other information pertaining to the song.

According to another embodiment, the first and second sets of data content generated by the method 600 comprise digital video files. Each such file can be capable of rendering a visual performance associated with the at least one keyword contained in the query and the at least one corresponding keyword associated with the data content stored in the data libraries. Generating another set by applying the quality assurance filter at step 604 can be done to eliminate from the first set of data content each video file that is incapable of rendering a complete version of the visual performance. The quality assurance filter can be applied at 604, additionally or alternatively, to eliminate from the first set of data content each video file found to have a bit rate less than a pre-selected threshold.

If the method 600 is applied to data content comprising visual files, then the method can further include applying tags to the files that provide one or more of the following: a name of an artist appearing in the visual performance, a visual performance rendered by a corresponding video file, commentary on the visual performance rendered by a corresponding video file, a recommendation about a visual performance rendered with a corresponding video file, a recommendation regarding a visual performance rendered by a corresponding audio file, viewer ratings of a visual performance rendered by a corresponding audio file, or other such information.

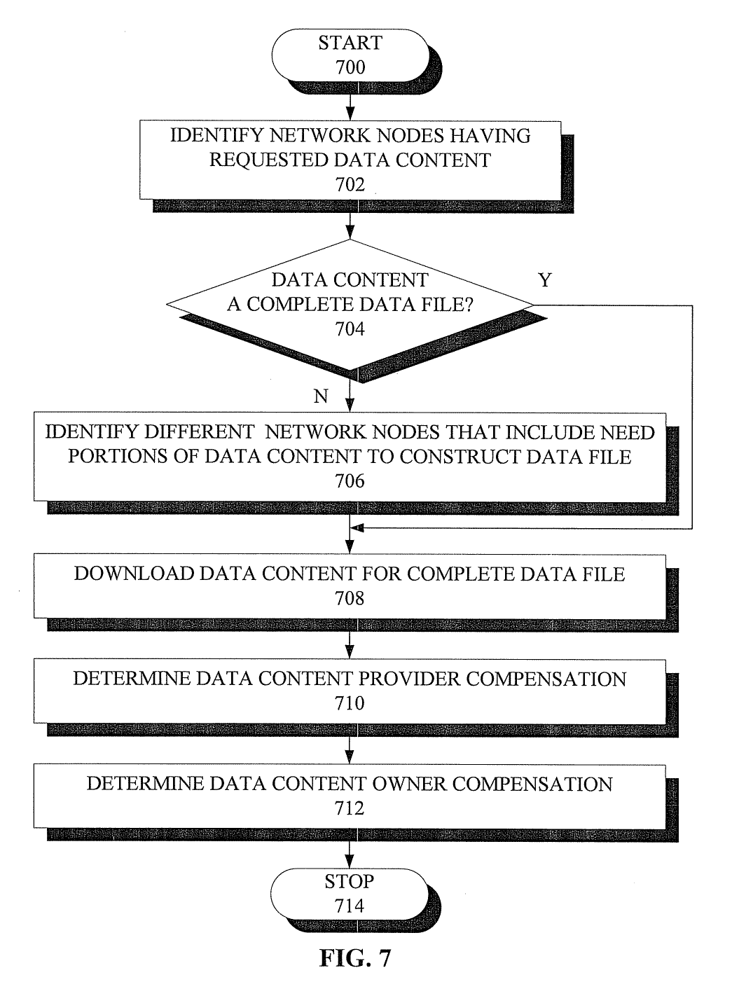

Still another embodiment of the invention is illustrated in FIG. 7. The figure is a flowchart of the exemplary steps of a method 700 for providing data content over a data communications network and for compensating data content providers and data content owners. The method 700, at step 702, illustratively includes identifying at least one network-connected node which stores requested data content at step 702 in response to a search query conveyed from a data content requester over the data communications network, the identification being based upon the search query. The requested data content can comprise a file such as an audio file for rendering a requested song or an audiovisual file for rendering a film performance. Different portions of the complete data file may be located at separate network nodes. Accordingly, at step 704, a determination is made whether the identified node completes the requested data file. If not, each of a plurality of nodes having different portions to complete the data file are identified at step 706. Then, once the network nodes that contain the different portions which in the aggregate complete the data file are identified, the data content is downloaded at step 708 to generate a complete data package.

The method 700 further illustratively includes at step 710 providing to each content provider at each of the different nodes a provider compensation based upon resources contributed from each node for delivering the complete data package to the data content requester. Additionally, the method 700 illustratively includes providing to an owner of the data content an owner compensation based upon a predetermined ownership compensation formula at step 712. The method illustratively concludes at step 714.

The invention can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be embedded in a computer program product, including a computer-readable storage medium in which is embedded a computer program or code for implementing the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computing device comprising:
an interface for communicating with a plurality of other computing devices over a data communications network;
an identifying module configured to identify at least one of the plurality of other computing devices as a provider computer that is capable of providing at least a portion of requested data content, the requested data content being requested by another of the plurality of computing devices defining a requester computer; and
a compensation-determining module for determining an amount of provider compensation for the at least one provider computer based upon an amount of resources provided by the at least one provider computer to the requestor computer for obtaining at least a portion of the requested data content, and for determining an amount of owner compensation for an owner of the data content provided to the requester computer.

2. The computing device of claim 1, wherein the requested data content comprises at least one of an audio file and a video file.

3. The computing device of claim 1, wherein the identifying module is further configured to identify a plurality of the other computing devices as provider computers that are capable of providing different portions of requested data content, wherein the different portions, when aggregated, form a complete data file identified in a request from the requester computer.

4. The computing device of claim 1, further comprising a filter for filtering portions of data content when two identical portions are provided by two different provider computers and one of the two identical portions has a quality higher than the other as determined based upon a predefined quality criterion.

5. The computing device of claim 1, wherein the resources contributed comprise bandwidth, and wherein the compensation-determining module is configured to determine the amount of provider compensation based upon the amount of bandwidth contributed.

6. A computing system comprising:
an interface for communicating with a plurality of computing devices over a data communications network;
a data set generator for generating a set of data content in response to a query conveyed over the data communications network, wherein the data set generator is configured to generate the set based upon at least one keyword contained in the query and at least one corresponding keyword associated with data content stored in data libraries at a plurality of network-connected nodes of the data communications network;
a quality assurance filter for generating an additional set by eliminating from the set of data content that fails to satisfy a predetermined quality criterion; and
a database of content tags in communication with the data set generator, the tags being associated with the set of data content and comprising at least one of commentary pertaining to the data content, recommendations regarding the data content, and user-supplied ratings of the data content.

7. The computing system of claim 6, wherein the data content comprises at least one digital audio file for rendering a song identified by the at least one keyword contained in the query and the at least one corresponding keyword associated with data content stored in data libraries at a plurality of network-connected nodes of the data communications network.

8. The computing system of claim 7, wherein the tags comprise at least one of a commentary pertaining to the song, recommendations regarding the song, commentary pertaining to an artist performing the song, recommendations regarding other songs performed by an artist performing the song, user-supplied ratings of the song, and user-supplied rating of an artist performing the song.

9. The computing system of claim 6, wherein the data content comprises at least one digital video file for rendering a visual performance identified by the at least one keyword contained in the query and the at least one corresponding keyword associated with data content stored in data libraries at a plurality of network-connected nodes of the data communications network.

10. The computing system of claim 9, wherein the tags comprise at least one of a commentary pertaining to the visual performance, recommendations regarding the visual performance, commentary pertaining to an artist appearing in the visual performance, a commentary pertaining to a director of the visual performance, a commentary pertaining to a script of the visual performance, recommendations regarding related visual performances, and user-supplied ratings of the visual performance.

11. A method for providing data content over a data communications network and for compensating data content providers and data content owners, the method comprising:
in response to a search query conveyed from a data content requester over the data communications network, identifying at least one network-connected node which stores at least a portion of data content identified based upon the search query;
if different portions of the data content are stored at different nodes, identifying each of the different nodes and downloading the respective portions of data content to generate a complete data package;
providing to each content provider at each of the different nodes a provider compensation based upon resources contributed from each node for delivering the complete data package to the data content requester; and
providing to an owner of the data content an owner compensation based upon a predetermined ownership compensation formula.

12. The method of claim 11, wherein the complete data package comprises an audio file for rendering a song identified by the search query.

13. The method of claim 11, wherein the complete data package comprises a video file for rendering a visual performance identified by the search query.

14. The method of claim 11, further comprising receiving compensation from the user.

15. The method of claim 14, further comprising allocating the received compensation among the content providers and the owner of the data content.

16. A method of providing data content over a data communications network, the method comprising:
in response to a query conveyed over the data communications network, generating a first set of data content based upon at least one keyword contained in the query and at least one corresponding keyword associated with data content stored in data libraries at a plurality of network-connected nodes of the data communications network;
generating a second set of data content by applying a quality assurance filter that eliminates from the first set of data content that fails to satisfy a predetermined quality criterion.

17. The method of claim 16, wherein the first and second sets of data content generated comprise digital audio files, each audio file capable of rendering a song associated with the at least one keyword contained in the query and the at least one corresponding keyword associated with the data content stored in the data libraries.

18. The method of claim 17, wherein applying the quality assurance filter comprises eliminating from the first set of data content each audio file contained therein that is incapable of rendering a complete version of the song associated with the at least one keyword contained in the query and the corresponding at least one keyword associated with the data content stored in the data libraries.

19. The method of claim 17, wherein applying the quality assurance filter comprises eliminating from the first set of data content each audio file having a bit rate less than a pre-selected threshold.

20. The method of claim 17, further comprising applying at least one tag to each audio file, each at least one tag comprising at least one of a name of an artist performing a song rendered by a corresponding audio file, track information of a corresponding audio file, commentary about a song rendered by a corresponding audio file, a recommendation regarding a song rendered by a corresponding audio file, recommendations regarding related songs rendered by a corresponding audio file, and ratings of a song rendered by a corresponding audio file.

21. The method of claim 16, wherein the first and second sets of data content generated comprise digital video files, each file capable of rendering a visual performance associated with the at least one keyword contained in the query and the at least one corresponding keyword associated with the data content stored in the data libraries.

22. The method of claim 21, wherein applying the quality assurance filter comprises eliminating from the first set of data content each video file contained therein that is incapable of rendering a complete version of the visual performance associated with the at least one keyword contained in the query and the corresponding at least one keyword associated with the data content stored in the data libraries.

23. The method of claim 21, wherein applying the quality assurance filter comprises eliminating from the first set of data content each video file having a bit rate less than a pre-selected threshold.

24. The method of claim 21, further comprising applying at least one tag to each visual file, each at least one tag comprising at least one of a name of an artist appearing in the visual performance, a visual performance rendered by a corresponding video file, commentary on the visual performance rendered by a corresponding video file, a recommendation about a visual performance rendered with a corresponding video file, a recommendation regarding a visual performance rendered by a corresponding audio file, and viewer ratings of a visual performance rendered by a corresponding audio file.
